(19) United States
(12) Patent Application Publication
(10) Pub. No.: US 2024/0219542 A1
(43) Pub. Date: Jul. 4, 2024

(54) Auto-level step for extrinsic calibration

(71) Applicant: Ouster, Inc., San Francisco, CA (US)

(72) Inventors: John Daly, Ottawa (CA); David Pike, Ottawa (CA)

(73) Assignee: Ouster, Inc., San Francisco, CA (US)

(21) Appl. No.: 18/404,262

(22) Filed: Jan. 4, 2024

Related U.S. Application Data
(60) Provisional application No. 63/478,405, filed on Jan. 4, 2023.

(51) Int. Cl. G01S 7/497; G01S 7/51

(52) U.S. Cl. CPC G01S 7/4972; G01S 7/51

(57) ABSTRACT

Techniques (e.g., methods, systems, devices) for receiving, from the lidar device, a measurement of the inertial measurement sensor. The techniques further including determining, using the measurement, at least one angle of a pitch angle or a roll angle of the lidar device. The techniques further including fixing the at least one angle of the lidar device in a graphical user interface that displays a location of the lidar device and providing one or more control elements in the graphical user interface that enable a user to specify one or more other degrees of freedom of the lidar device.

### CROSS REFERENCES TO RELATED APPLICATIONS

The application claims benefit of U.S. Provisional Application No. 63/478,405, filed Jan. 4, 2023, the entire contents of which is hereby incorporated by reference for all purposes.

### BACKGROUND

Light ranging systems, such as light detection and ranging (LiDAR) systems, may be used to assist with monitoring an environment, including around a building, vehicle, and/or other structure. After installing a sensing device, such as a lidar device, it can be useful to know the location of the device with respect to the environment the device has been installed in. For example, the device may be mounted in a corner of a room on the ceiling and pointed downward. The X, Y, and Z positioning of the device with respect to other devices in the room, objects in the room, and/or a point in the room may be useful for performing computations, reconstructing point clouds, etc. Furthermore, the yaw, pitch, and role of the installed device may be useful for performing computations, reconstructing point clouds, etc. It may be difficult to know such positioning of the device.

It may be difficult for a user to accurately represent the device positioning in a user interface for various reasons. For example, the installed device may be in a hard-to-reach area, may be far from a desired reference point (e.g., other device, object, and/or origin). Further, the user configuring the device may not have the technical know-how to determine the location of the device defined by six degrees of freedom. Even in the case that a user does have the technical know-how to determine the location of the device, the user may spend a long time and therefore use unnecessary computational and energy resources to reflect the installed device positioning in a user interface used for configuring the installed device.

There is a need for ways for a user to more easily and accurately configure a sensor device so that the data generated and/or obtained by the sensor device may have a higher accuracy and to reduce the time and energy needed to configure the sensor device.

### BRIEF SUMMARY

According to some embodiments, a method can comprise: performing by a computer system in communication with a first lidar device that includes a first inertial measurement sensor: receiving, from the first lidar device, a measurement of the first inertial measurement sensor; determining, using the measurement, at least one angle of a pitch angle or a roll angle of the first lidar device; fixing the at least one angle of the first lidar device in a graphical user interface that displays a location of the first lidar device; and providing one or more control elements in the graphical user interface that enable a user to specify one or more other degrees of freedom of the first lidar device.

According to other embodiments, a lidar device can comprise: a lidar unit that includes emitters configured to emit light and sensors configured to detect reflected light; an inertial measurement sensor that performs a measurement at least one angle of a pitch angle or a roll angle of the lidar device; and a network interface configured to receive a request for the measurement and to provide the measurement to a computer system.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 shows an example of a light ranging system having a scanning LiDAR device installed on top of a structure, according to some embodiments.

FIG. 2 shows an example of a light ranging system having a solid-state LiDAR device installed on top of a structure, according to some embodiments.

FIG. 3 shows a block diagram of an example of a LiDAR device for implementing various embodiments.

FIG. 4 illustrates an example of a light ranging system 400 that can assist in the configuration of one or more sensor devices.

FIG. 5A shows an example lidar device having a dome and an angled lidar unit.

FIG. 5B shows a coverage of a lidar unit with light beams being emitted from the lidar unit, according to certain embodiments.

FIG. 6 shows a coverage of an angled lidar unit that is configured to rotate depicted with rings, according to certain embodiments.

FIG. 7A shows a first UI presentation of two lidar devices with their corresponding point clouds, according to certain embodiments.

FIG. 7B shows a second UI presentation including two lidar devices where the first point cloud and the second point clouds align, according to certain embodiments.

FIG. 8 shows a third UI with a circular first control element around the first lidar device that may be used for adjusting the yaw angle, according to certain embodiments.

FIG. 9 shows a fourth UI with an automatic align feature, according to certain embodiments.

FIG. 10 shows a process for calibrating a sensor location, according to certain embodiments.

FIG. 11 shows an example of a block diagram of example computer system for implementing various embodiments.

### TERMS

The following terms may be helpful for describing embodiments of the present technology.

The term “ranging,” particularly when used in the context of methods and devices for measuring an environment, may refer to determining a 2D or 3D distance or a distance vector from one location or position to another location or position. “Light ranging” may refer to a type of ranging method that makes use of electromagnetic waves to perform ranging methods or functions. Accordingly, a “light ranging device” may refer to a device for performing light ranging methods or functions. “LiDAR” (also “lidar” or “LIDAR”) may refer to a type of light ranging method that measures a distance to a target by illuminating the target with a pulsed laser light, and thereafter measure the reflected pulses with a sensor. Accordingly, a “LiDAR device” or “LiDAR system” may refer to a type of light ranging device for performing LiDAR methods or functions. A “light ranging system” may refer to a system comprising at least one light ranging device, e.g., a LiDAR device. The system may further comprise one or more other devices or components, in various arrangements.

“Location” and “position” may be used synonymously to refer to a point in two or three-dimensional space that may be represented as having an x, y, and z coordinate. In certain contexts, a location or position can be temporal as opposed to physical.

“Scan” and “scanning” may refer to performing one or more measurements of an object or an environment from one or more locations using a light ranging device. A scan may be of a structure's exterior. A “structure exterior” or “the exterior of a structure” may refer to the outermost surface of the structure.

A “model” may be a digital representation of a physical object. For example, a model of a structure exterior may be a digital representation of the exterior of the structure, such as a three-dimensional or two-dimensional visual representation. The visual representation may take the form of a collection of points having positions in a two-dimensional or three-dimensional space, or a mesh having vertices at various positions in a two-dimensional or three-dimensional space. The representation may further be displayed and viewed by a user.

A “proximity” or a “proximity value” may refer to a type of risk value that relates to the potential for an environmental object to collide with the structure. It may be a function of various factors including the distance between the environmental object and the structure, the velocity of the environmental object relative to the structure, the direction in which the environmental object may be travelling relative to the structure, and any other factors that may be relevant to the risk of a potential collision between the structure and the environmental object.

A “coordinate frame” may refer to a three-dimensional coordinate system having an x, y, and z dimension that may be used to define data points in a model of the structure exterior and/or additional environmental structures around the structure, wherein the model of the structure exterior may be in the form of a mapping comprising a plurality of data points corresponding to points on the structure exterior and/or the surfaces of environmental structures.

### DETAILED DESCRIPTION

The present disclosure generally relates to the configuration of sensor devices (e.g., lidar devices). The configuration of a sensor device may reflect the installation of the sensor device. The configuration of the sensor device may reflect the location at which the sensor device was installed. The location of the sensor device may be up to six degrees of freedom. The six degrees of freedom may be defined by a three dimensional coordinate position (e.g., X, Y, Z) and by a pitch angle, role angle, and yaw angle. For example, the sensor may be installed in a corner of a room at a specific coordinate position and at a specific angle. The data collected by the sensor device after installation at the location may be used to inform the configuration of the sensor device. For example, the sensor may collect data relating to measured object distances from the sensor and be capable of generating a point cloud based on the measured distances. A sensor device may be a lidar device capable of measuring distances of objects from the sensor device and generating a point cloud based on the object distances.

Based on the data collected by the sensor device, the installation location (e.g., coordinate position (e.g., X-Y-Z) and angle (e.g., pitch, role, yaw)) may be used to configure how the data for the device is used. The configuration may be performed in an automated, semi-automated, or manual fashion. In an example, the installation location may be configured to be accurately reflected on a graphical user interface that includes a map of an area that includes the sensor device. A user of the graphical user interface may be capable of setting up the sensor device and/or a second sensor device based on the data generated by the sensor device and/or the second sensor device. The graphical user interface may allow the user to more efficiently and effectively configure the sensor device and/or any number of other sensor devices.

Configuring the location of the sensor device may be aided by an inertial measurement sensor (IMS). The sensor device (e.g., lidar device) can include the IMS (e.g., an accelerometer). The IMS can be used to measure the down direction via the force of gravity. Knowing the down direction allows for the measurement of the pitch and the roll of the device, which are two of the six degrees of freedom that define the sensor device location. Once these two degrees of freedom are known, the process of determining the other four degrees of freedom is much easier. A user interface can be provided with a pitch angle and/or a roll angle being fixed, where the user can specify the other degrees of freedom.

In some embodiments, an extrinsic sensor device configuration process can involve calculating a vector pointing in the direction of gravity from the IMS. Understanding this direction as down, the system can define a “level transform” as the transform in the same position as the sensor device but with the positive Z-axis pointing in the up direction relative to gravity. The system can send the transform taking points in the sensor device frame and representing them in the level transform to the user so the user does not have to adjust the pitch and roll of the sensor device in the world frame and may only worry about the yaw and position. The user can manipulate the transform from the level transform to the world point, and the software can automatically apply the transform from the sensor device to the level up transform.

### I. Example Light Ranging Device

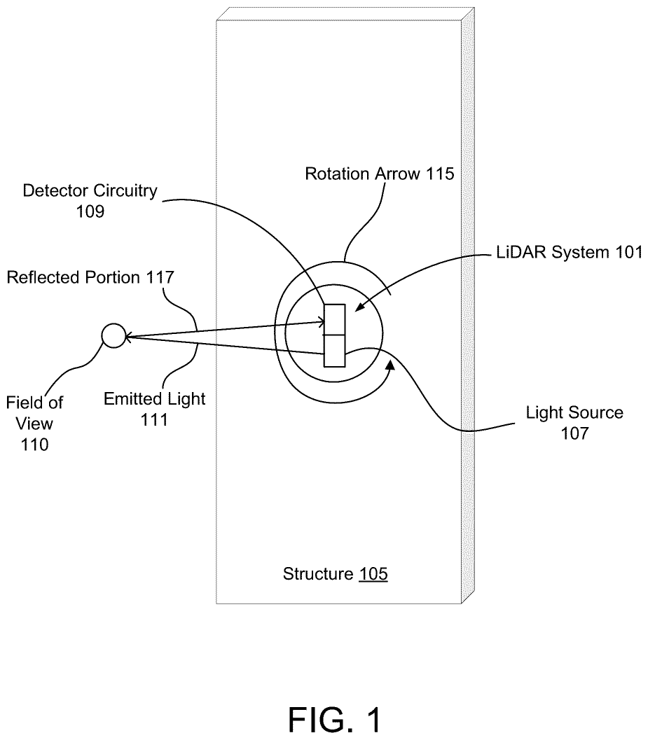

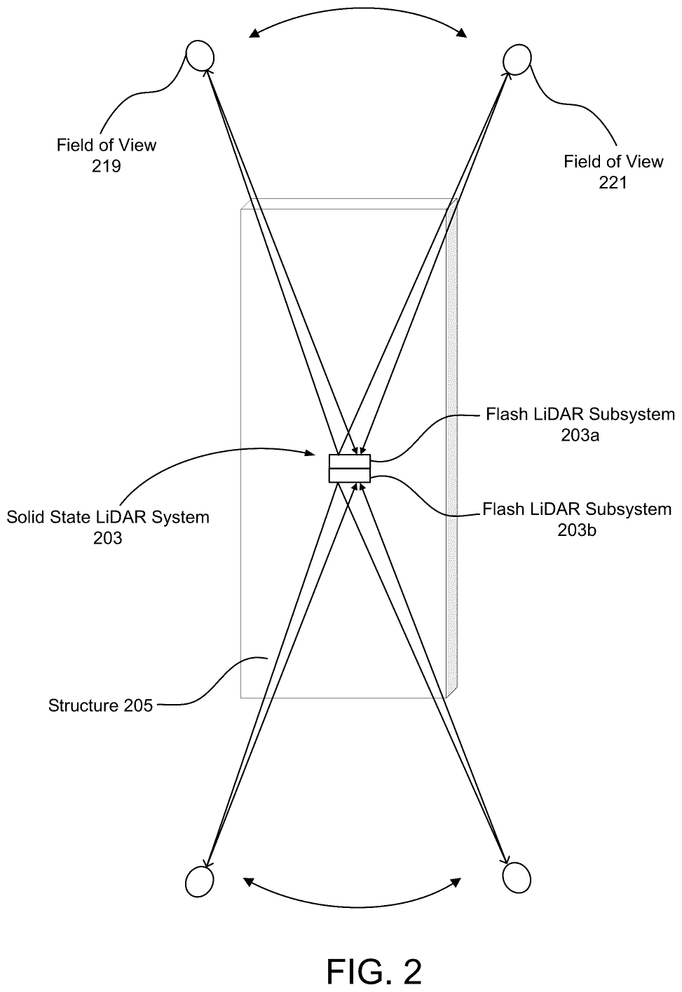

FIGS. 1-2 show light ranging devices, also referred to herein as LiDAR systems, according to some embodiments. The structural application for the LiDAR systems is chosen here merely for the sake of illustration and the sensors described herein may be employed in any building (e.g., internally, externally), vehicle or fleet of vehicles (e.g., boats, aircraft, trains, etc.), or in any application where 3D depth images are useful, e.g., in medical imaging, geodesy, geomatics, archaeology, geography, geology, geomorphology, seismology, forestry, atmospheric physics, laser guidance, airborne laser swath mapping (ALSM), security, and laser altimetry. A LiDAR system, e.g., scanning LiDAR system 101 and/or solid state LiDAR system 203, may be mounted on the roof of a structure (e.g., building) 105 as shown in FIGS. 1 and 2.

The scanning LiDAR system 101 shown in FIG. 1 can employ a scanning architecture, where the orientation of the LiDAR light source 107 and/or detector circuitry 109 can be scanned around one or more fields of view 110 within an external field or scene that is external to the structure 105. In the case of the scanning architecture, the emitted light 111 can be scanned over the surrounding environment as shown. For example, the output beam(s) of one or more light sources (such as infrared or near-infrared pulsed IR lasers, not shown) located in the LiDAR system 101, can be scanned, e.g., rotated, to illuminate a scene around the structure.

In some embodiments, the scanning, represented by rotation arrow 115, can be implemented by mechanical means, e.g., by mounting the light emitters to a rotating column or platform. In some embodiments, the scanning can be implemented through other mechanical means such as through the use of galvanometers. Chip-based steering techniques can also be employed, e.g., by using microchips that employ one or more micro-electromechanical system (MEMS) based reflectors, e.g., such as a digital micromirror (DMD) device, a digital light processing (DLP) device, and the like. In some embodiments, the scanning can be effectuated through non-mechanical means (e.g., by using electronic signals to steer one or more optical phased arrays).

FIG. 2 shows an example of a light ranging system having a solid-state LiDAR device installed on top of a structure (e.g., building, vehicle, sign, bridge, etc.) according to some embodiments. For a stationary architecture, like solid state LiDAR system 203 shown in FIG. 2, one or more flash LiDAR subsystems (e.g., 203a and 203b) can be mounted to a structure 205. Each solid state LiDAR unit can face a different direction (possibly with partially and/or non-overlapping fields of views between units) so as to capture a composite field of view that is larger than each unit is capable of capturing on its own.

In either the rotating or stationary architectures, objects within the scene can reflect portions of the light pulses that are emitted from the LiDAR light sources. One or more reflected portions then travel back to the LiDAR system and can be detected by the detector circuitry. For example, in FIG. 1, reflected portion 117 can be detected by detector circuitry 109. The detector circuitry can be disposed in the same housing as the emitters. Aspects of the scanning system and stationary system are not mutually exclusive and thus can be used in combination. For example, the individual LiDAR subsystems 203a and 203b in FIG. 2 can employ steerable emitters such as an optical phased array or the whole composite unit may rotate through mechanical means thereby scanning the entire scene in front of the LiDAR system, e.g., from field of view 219 to field of view 221.

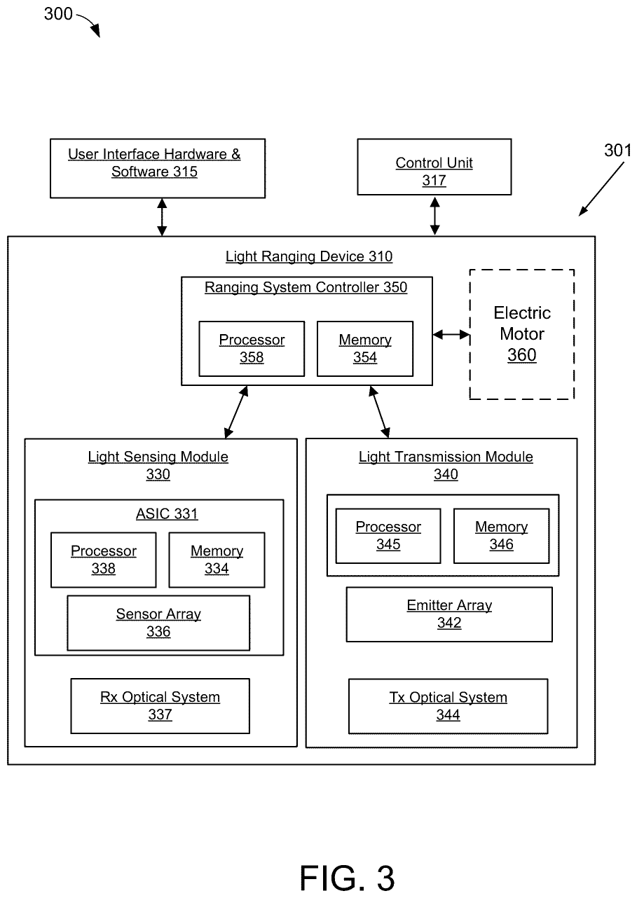

FIG. 3 illustrates a more detailed block diagram of a rotating LiDAR system 301 according to some embodiments. More specifically, FIG. 3 optionally illustrates a rotating LiDAR system that can employ a rotary actuator on a rotating circuit board, which receives power and transmits and receives data from a stationary circuit board.

LiDAR system 301 can interact with one or more instantiations of user interface hardware and software 315. The different instantiations of user interface hardware and software 315 can vary and may include, for example, a computer system with a monitor, keyboard, mouse, CPU and memory; a touch-screen; a handheld device with a touch-screen; or any other appropriate user interface. The user interface hardware and software 315 may be local to the object upon which the LiDAR system 301 is mounted but can also be a remotely operated system. For example, commands and data to/from the LiDAR system 301 can be routed through a cellular network (LTE, etc.), a personal area network (Bluetooth, Zigbee, etc.), a local area network (WiFi, IR, etc.), or a wide area network such as the Internet.

The user interface hardware and software 315 can present the LiDAR data from the device to the user but can also allow a user to control the LiDAR system 301 with one or more commands. Example commands can include commands that activate or deactivate the LiDAR system, specify photo-detector exposure level, bias, sampling duration and other operational parameters (e.g., emitted pulse patterns and signal processing), specify light emitters parameters such as brightness. In addition, commands can allow the user to select the method for displaying results. The user interface can display LiDAR system results which can include, e.g., a single frame snapshot image, a constantly updated video image, an accumulated image of data over time into a map, a simplified projected view of a three-dimensional environment around a structure, associated data overlaid on the LiDAR data like color or texture, and/or a display of other light measurements for some or all pixels such as ambient noise intensity, return signal intensity, calibrated target reflectivity, target classification (hard target, diffuse target, retroreflective target), range, signal to noise ratio, target radial velocity, return signal temporal pulse width, signal polarization, noise polarization, and the like. In some embodiments, user interface hardware and software 315 can track distances of objects from the structure, and potentially provide alerts to a driver or provide such tracking information for analytics of a driver's performance.

In some embodiments, the LiDAR system can communicate with a control unit 317 and one or more parameters associated with control of a structure can be modified based on the received LiDAR data. For example, in a building settings, the LiDAR system can provide a real-time 3D image of the environment surrounding the building to aid in security. When a control unit 317 is communicatively coupled to light ranging device 310, alerts can be provided to a user (e.g., administrator) or a proximity of an object (e.g. a shortest distance between the object and the structure) can be tracked, such as for evaluating a threat level, an interaction, available space (e.g., parking, seating), etc. In an example, the LiDAR system may have a field of view that is external and/or internal to the structure of which the LiDAR system is installed on and/or within.

In an example, in a fully autonomous vehicle, the LiDAR system can provide a real-time 3D image of the environment surrounding the car to aid in navigation. In other cases, the LiDAR system can be employed as part of an advanced driver-assistance system (ADAS) or as part of a safety system that, e.g., can provide 3D image data to any number of different systems (e.g., adaptive cruise control, automatic parking, driver drowsiness monitoring, blind spot monitoring, collision avoidance systems, etc.). When a control unit 317 is communicatively coupled to light ranging device 310, alerts can be provided to a driver or a proximity of an object (e.g. a shortest distance between the object and the vehicle exterior) can be tracked, such as for evaluating a driver.

The LiDAR system 301 shown in FIG. 3 includes the light ranging device 310. The light ranging device 310 includes a ranging system controller 350, a light transmission (Tx) module 340 and a light sensing (Rx) module 330. Ranging data can be generated by the light ranging device by transmitting one or more light pulses from the light transmission module 340 to objects in a field of view surrounding the light ranging device. Reflected portions of the transmitted light are then detected by the light sensing module 330 after some delay time. Based on the delay time, the distance to the reflecting surface can be determined. Other ranging methods can be employed as well, e.g. continuous wave, Doppler, and the like.

The Tx module 340 includes an emitter array 342, which can be a one-dimensional or two-dimensional array of emitters, and a Tx optical system 344, which when taken together can form an array of micro-optic emitter channels. Emitter array 342 or the individual emitters are examples of laser sources. The Tx module 340 further includes optional processor 345 and memory 346, although in some embodiments these computing resources can be incorporated into the ranging system controller 350. In some embodiments, a pulse coding technique can be used, e.g., Barker codes and the like. In such cases, memory 346 can store pulse-codes that indicate when light should be transmitted. In one embodiment the pulse-codes are stored as a sequence of integers stored in memory.

The Rx module 330 can include sensor array 336, which can be, for example, a one-dimensional or two-dimensional array of photosensors. Each photosensor (also just called a sensor) can include a collection of photon detectors (e.g., SPADs or the like), or a sensor can be a single photon detector (e.g., an APD). Like the Tx module 340, Rx module 330 includes an Rx optical system 337. The Rx optical system 337 and sensor array 336 taken together can form an array of micro-optic receiver channels. Each micro-optic receiver channel measures light that corresponds to an image pixel in a distinct field of view of the surrounding volume. Each sensor (e.g., a collection of SPADs) of sensor array 336 can correspond to a particular emitter of emitter array 342, for example, as a result of a geometrical configuration of light sensing module 330 and light transmission module 340.

In one embodiment, the sensor array 336 of the Rx module 330 can be fabricated as part of a monolithic device on a single substrate (using, e.g., complementary metal-oxide-semiconductor (CMOS) technology) that includes both an array of photon detectors and an application-specific integrated circuit (ASIC) 331 for signal processing the raw signals from the individual photon detectors (or groups of detectors) in the array. As an example of signal processing, for each photon detector or grouping of photon detectors, memory 334 (e.g., SRAM) of the ASIC 331 can accumulate counts of detected photons over successive time bins, and these time bins taken together can be used to recreate a time series of the reflected light pulse (i.e., a count of photons vs. time). This time-series of aggregated photon counts is referred to herein as an intensity histogram (or just histogram). In addition, the ASIC 331 can accomplish certain signal processing techniques (e.g., by a processor 338), such as matched filtering, to help recover a photon time series that is less susceptible to pulse shape distortion that can occur due to SPAD saturation and quenching. In some embodiments, one or more components of the ranging system controller 350 can also be integrated into the ASIC 331, thereby eliminating the need for a separate ranging controller module.

In some embodiments, one or more of the individual components of the Rx optical system 337 can also be part of the same monolithic structure as the ASIC, with separate substrate layers for each receiver channel layer. For example, an aperture layer, collimating lens layer, an optical filter layer and a photo-detector layer can be stacked and bonded at the wafer level before dicing. The aperture layer can be formed by laying a non-transparent substrate on top of a transparent substrate or by coating a transparent substrate with an opaque film. In yet other embodiments, one or more components of the Rx module 330 may be external to the monolithic structure. For example, the aperture layer may be implemented as a separate metal sheet with pin-holes.

In some embodiments, the photon time series output from the ASIC is sent to the ranging system controller 350 for further processing, e.g., the data can be encoded by one or more encoders of the ranging system controller 350 and then sent as data packets via the optical downlink. Ranging system controller 350 can be realized in multiple ways including, e.g., by using a programmable logic device such an FPGA, as an ASIC or part of an ASIC, using a processor 358 with memory 354, and some combination of the above. The ranging system controller 350 can cooperate with a stationary base controller or operate independently of the base controller (via pre-programed instructions) to control the light sensing module 330 by sending commands that include start and stop light detection and adjust photo-detector parameters.

Similarly, the ranging system controller 350 can control the light transmission module 340 by sending commands, or relaying commands from the base controller, that include start and stop light emission controls and controls that can adjust other light-emitter parameters such as emitter temperature control (for wavelength tuning), emitter drive power and/or voltage. If the emitter array has multiple independent drive circuits, then there can be multiple on/off signals that can be properly sequenced by the ranging system controller. Likewise, if the emitter array includes multiple temperature control circuits to tune different emitters in the array differently, the transmitter parameters can include multiple temperature control signals. In some embodiments, the ranging system controller 350 has one or more wired interfaces or connectors for exchanging data with the light sensing module 330 and with the light transmission module 340. In other embodiments, the ranging system controller 350 communicates with the light sensing module 330 and light transmission module 340 over a wireless interconnect such as an optical communication link.

The electric motor 360 is an optional component needed when system components (e.g., the Tx module 340 and/or Rx module 330) need to rotate. The system controller 350 controls the electric motor 360 and can start rotation, stop rotation and vary the rotation speed.

### II. Installation and Operation of Light Ranging System

One or more light ranging devices, such as the example light ranging devices described above with respect to FIGS. 13, may form a light ranging system that may be installed in and/or on a building (e.g., as opposed to a car). The light ranging system may perform machine vision functions such as object recognition, object tracking, etc. The system may be used for the purposes of monitoring an area nearby the light ranging system. The light ranging system may further comprise other types of components such as interfaces for interacting with a user, computer systems for processing data, other types of sensing devices for collecting data, communication channels for transferring data between system components, and other components that may support the functionality of the light ranging system.

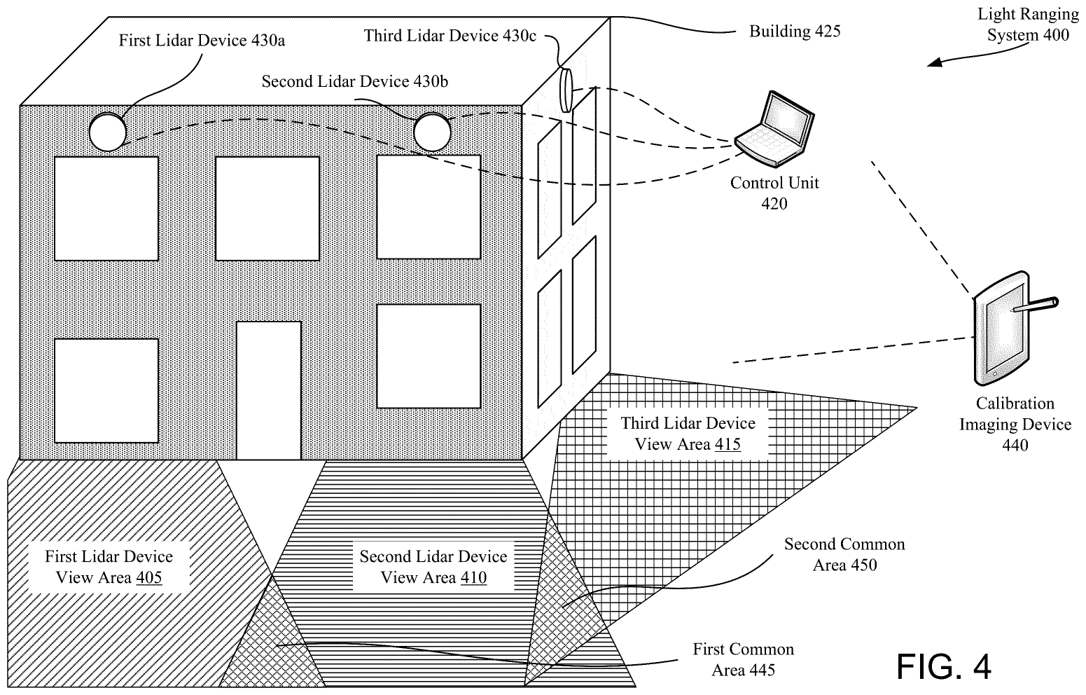

FIG. 4 illustrates an example of a light ranging system 400 that can assist in the configuration of one or more sensor devices. The light ranging system 400 can assist in the operation of building security, 3D modeling, etc. The light ranging system can assist in the configuration of one or more sensor devices (e.g., lidar devices 430).

### A. Lidar Devices

In the illustrated light ranging system 400, the building 425 includes a first lidar device 430a, a second lidar device 430b, and a third lidar device 430c. The three lidar devices 430a-430c may be the lidar devices previously described with respect to FIGS. 1 and 2. Each lidar device 430 may be installed on (e.g., coupled with) at least on surface of the building 425. For example, the first lidar device 430a and the second lidar device 430b are installed on a first surface of the building 425 that is an external wall to the building 425 and the third lidar device 430c is installed on a second surface of the building 425 that is an external wall to the building 425.

Any number (e.g., zero or more) of sensor devices may be disposed on the same surface as another sensor device. A sensor device may be disposed on more than one surface. For example, the sensor device may be mounted in an internal corner and therefore be coupled with a ceiling surface, a first internal wall surface, and a second internal wall surface.

In certain embodiments, the sensor devices (e.g., the first lidar device 430a, the second lidar device 430b, etc.) may be installed such that the line of sight of the sensor devices overlap and cause an area in common to be sensed by the sensor devices. For example, the first lidar device 430a may be installed at a first location and the second lidar device 430b may be installed at a second location. The location of a sensor device may be defined by a coordinate position (e.g., X position, Y position, Z position) and angles (e.g., pitch, roll, yaw). The location of the first lidar device 430a may enable the first lidar device 430a to scan a first lidar device view area 405. The location of the second lidar device 430b may enable the second lidar device 430b to scan a second lidar device view area 410. The second lidar device view area 410 may include a first common area 445 that is also included in the first lidar device view area 405.

In certain embodiments, the sensor devices (e.g., the first lidar device 430a, the second lidar device 430b, etc.) may be installed such that the line of sight of the sensor devices do not overlap and do not cause an area in common to be sensed by the sensor devices. Thus, a sensor device may include a view area that is unique from another view area of another sensor device.

A control unit 420 may process the data collected by sensor devices (e.g., the first lidar device 430a, the second lidar device 430b, the third lidar device 430c). The location of the lidar devices 430 are for illustrative purposes only and that in some instances the lidar devices 430 can be mounted in a recess or similar cavity of the building 425 so that they appear flush or near flush with one or more exterior interior surfaces of the building 425, thereby providing an attractive aesthetic appearance.

It is understood that any number of lidar devices 430 may be installed on the building 425 and that the lidar devices 430 may be arranged in a variety of configurations on the building 425 in alternative embodiments. In a light ranging system 400 having multiple lidar devices 430, the lidar devices 430 may be placed around the building 425 as to maximize the amount of the environment surrounding the building 425 the lidar devices 430 may collectively sense. In other words, the lidar devices 430 may be placed around the building 425 as to maximize a coverage area of the light ranging system 400.

Using an arrangement, the lidar devices 430 can provide good coverage over the environment surrounding the building 425 with minimal blind spots. There may be overlap (e.g., substantial) between the coverage areas of the three lidar devices 430. Furthermore, there may be regions of the environment that cannot be sensed by any of the lidar devices 430 since the corners of the building and/or other objects within or near the building 425 may block the field of view or line of sight of one or more lidar devices 430. Although the lidar devices 430 are illustrated as installed on a building 425, the lidar devices may be installed in various locations, such as a vehicle, inside a building, on a building, on a pillar, on a sign, etc.

### B. Control Unit

The lidar devices 430a-430c may survey (i.e., performing ranging measurements) the environment to collect ranging data and transfer the ranging data to a control unit 420. The control unit 420 may perform the same functions as the control unit 317. The ranging data may then be processed and analyzed by the control unit 420. The transfer of the ranging data may be conducted via a communication channel, which may be a wired communication channel comprising a cable that connects the light ranging devices 430 to the control unit 420. Alternatively, the control unit 420 may also be a wireless communication channel such as Bluetooth or Wi-Fi. It is understood that the ranging data may also be processed and analyzed on the lidar device 430 without having to transfer the ranging data to a separate control unit 420 or device in alternative embodiments. The ranging data or processed information (e.g., information about a breach or other event) can be transmitted wireless to a building 425 monitoring system and/or sensor device configuration system (e.g., using any suitable radio technology). In some implementations, the control unit 420 can communicate with various lidar devices installed on other buildings, rooms, areas, structures, objects, and/or vehicles, etc.

The control unit 420 may comprise a computer system having a processor and memory for performing various computational functions, a communicator for interfacing and communicating with other devices within or external to the light ranging system 400, and interface elements such as a graphical display, speakers, and a camera for interacting with users of the light ranging system 400 and/or a user of the control unit 420 (e.g., user of a graphical user interface displayed on the control unit 420).

In one embodiment, the control unit 420 may be a laptop. In an embodiment, the core processing components of the control unit 420 may be in a separate device from the interface elements. For example, the core processing components may be in a device that is mounted on top of the building 425, or may be operating remotely (e.g., remote server), leaving only the interface elements on the control unit 420. It is understood that other configurations of the control unit 420 and its components may be possible in alternative embodiments.

### C. Calibration Device

The light ranging system 400 may further comprise a calibration imaging device 440 that may be used to configure the light ranging system 400 by performing a full body (360-degree) scan of the building 425 to generate a digital model of the building 425 exterior. For example, a user may walk around building 425 to obtain a relatively complete scan of the building's 425 exterior. The model may be used to assist with proximity detection.

The calibration imaging device 440 may be a light ranging device and may be the same type of light ranging device, such as a LiDAR device, as the three lidar devices 430a-430c installed on the building 425. It is understood that the calibration imaging device 440 may also be any device that is capable of performing a scan of the building 425 to produce imaging data (e.g., ranging data) that may be used to construct a digital model of the building 425 exterior, interior, etc.

The calibration imaging device 440 may further comprise a computing system having a processor, a memory, a touch screen for interacting with a driver or user, and a communicator, such as a Bluetooth or Wi-Fi transceiver, for communicating with the control unit 420. For example, the calibration imaging device 440 may be a tablet device having the above mentioned components as well as a built-in LiDAR sensor. In one embodiment, the processor and memory of the calibration imaging device 440 may process the imaging data collected by the built-in LiDAR sensor and generate the model of the building 425 exterior. The communicator of the calibration imaging device 440 may then send the model of the building 425 exterior to the control unit 420 for use in proximity detection.

In an alternative embodiment, the communicator may send the collected imaging data to the control unit 420 wherein the imaging data is used by the control unit 420 to generate the model of the building 425 exterior. In yet another alternative embodiment, the communicator may send the collected imaging data to a remote server wherein the imaging data is used by the server to generate the model of the building 425 exterior wherein the model may then be transmitted back to the control unit 420.

### III. Calibrating a Sensor System

The light ranging system 400 described with respect to FIG. 4 may be installed and configured using a user interface (e.g., graphical user interface of control unit 420).

In some embodiments, an estimate of the model positions of each sensor device (e.g., lidar device 430) may be determined. In one embodiment, default positions may be used as the estimated positions or an initial guess for where the sensor devices (e.g., lidar devices 430) may be. The initial guess may then be subsequently refined to determine the actual positions (i.e., physical positions) of the sensor (e.g., lidar devices 430). In one embodiment, the estimated positions may be determined based on user input. For example, the calibration imaging device 440 may comprise a touchscreen that displays a constructed model of the building 425 to the user, who may then indicate on the touchscreen the approximate positions for where the lidar devices 430 are positioned on the building 425. The estimate can ensure that the model positions are corresponding to the physical positions of the lidar devices 430.

In another embodiment, the estimated positions may be automatically determined by a processor, either on the calibration imaging device 440 or the control unit 420 or an external server. For example, a control unit 420 may know the housing dimensions of the lidar device 430 and determine where the housing dimensions of the lidar device 430 matches (aligns) with what appears to be a lidar device 430 on the primary model. The one or more housing dimensions can include any combination of length, width, and height, as well as shape. Upon finding one or more successful matches on the primary model with the preconfigured model of the lidar device 430, the positions for where the match took place may be set as the estimated positions for the one or more lidar devices 430.

Accordingly, such extrinsic calibration of each lidar device 430 (or other sensor device) can be obtained by aligning its output with the primary model and/or with the environment. Since this alignment process can use an initial guess in order to converge, embodiments can use a method similar to random sample consensus. For example, random orientations and positions (up to 100,000 times) can be selected until a large majority of points are well-aligned. Points similar to those that are well-aligned (e.g., minor offsets with the random number) can be selected so as to refine the search near the well-aligned points, thereby focusing the search.

### IV. Lidar Device

In some embodiments, the lidar device can be installed on a ceiling or a wall of a building, e.g., facing internally or externally. Other example physical locations are installing the lidar device on a light post or a pole at an roadway intersection, walkway intersection, etc. The lidar device may be capable of obtaining sensor measurements such as distances of surfaces from the lidar device. The lidar device may be installed on a ceiling, wall, floor, etc. of a building or other structure and may obtain distance measurements from a field of view from the perspective of the lidar device. The field of view of the lidar device may be determined by the angle of the lidar unit, the number of light beams emitted by the lidar device, the location (e.g., position and angles) of the lidar device, and/or the rotatability of the lidar device.

### A. Angled Lidar Device

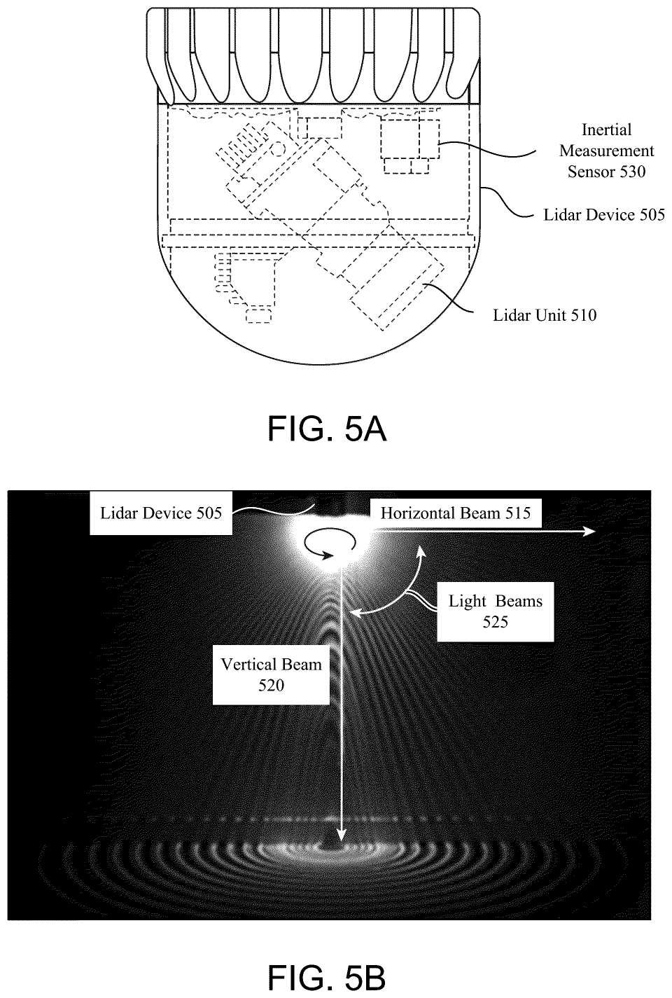

FIG. 5A shows an example lidar device 505 having a dome and an angled lidar unit 510. The lidar device 505 may function similarly to any of the light ranging devices described above.

An inertial measurement sensor (IMS) 530 can be included in or attached to a housing of the lidar unit 510. For example, an IMS 530 can include an accelerometer. The IMS 530 may be capable of determining the down direction via sensing the force of gravity. Determining the down direction may allow for the measurement of the pitch and/or the roll of the lidar unit 510 and may allow for the measurement of the pitch and the roll of the lidar device 505.

Once the pitch and/or the roll of the lidar unit 510 are determined, one or two of the six degrees of freedom of the lidar unit 510 may be known. By determining one or two of the six degrees of freedom of the lidar unit 510, the amount of time and processing resources for configuring the lidar unit 510 can be reduced since less than six degrees of freedom of the lidar unit 510 may need to be configured after the determination using the IMS 530. Further, the accuracy of subsequent calculations based on the determined pitch and/or role of the lidar unit 510 may be improved because the pitch and/or role of the lidar unit 510 has been determined using the IMS 530 as opposed to using user input, for example.

### B. First Example of Lidar Device Coverage

FIG. 5B shows a coverage of a lidar device 505 with light beams being emitted from the lidar unit, according to certain embodiments. The lidar device 505 may be lidar device 505 shown in FIG. 5A or any other lidar device discussed herein.

The lidar device 505 may be configured to emit any number of light beams 525. In certain embodiments, the lidar device 505 is configured to emit 128 light beams 525. In certain embodiments, the lidar device 505 is configured to rotate. The lidar device 505 may rotate about one or more axes. In certain embodiments, the lidar device 505 is mounted on a surface such that the light beams 525 are directed away from the surface. For example, the lidar device 505 may be mounted on a ceiling or a wall and emit light down toward the ground (e.g., based on the lidar device 505 installation location and/or the lidar unit 510 angle).

The lidar device 505 may emit a vertical beam 520 independent of the lidar unit 510 position at an angle perpendicular to the surface that the lidar device 505 is mounted on. The lidar unit 510 may be capable of being angled to emit the vertical beam 520. The lidar unit 510 may be configured and/or installed to be angled at a fixed angle or may be capable of mechanically sweeping about an axis and change its angle of rotation during operation of the lidar unit 510.

The lidar device 505 may emit a horizontal beam 515 at an angle parallel to the surface that the lidar device 505 is mounted on, independent of the lidar unit 510 position. The lidar unit 510 may be capable of being angled to emit the horizontal beam 515. The lidar unit 510 may be configured and/or installed to be angled at a fixed angle or may be capable of mechanically sweeping about an axis and change its angle of rotation during operation of the lidar unit 510.

The lidar device 505 may include any number (e.g., 126) of beams 525 emitted between (e.g., equally spaced) the horizontal beam 515 and the vertical beam 520.

In certain embodiments, the light beams 525 of the lidar device 505 may reflect off of one or more surfaces. For example, the light beams 525 of the lidar device 505 may reflect off of a ground (e.g., street, sidewalk, interior floor, steps, etc.) surface within the line of sight of the lidar device 505. For example, the light beams 525 of the lidar device 505 may reflect off of a non-ground surface (e.g., wall, person, car, lamp post, etc.) within the line of sign of the lidar device 505. The lidar device 505 may be configured to emit light in a pattern, such as the pattern shown in FIG. 5B (e.g., a ring pattern may be created due to the distance between emitted light beams 525 and the rotation of the lidar device 505).

### C. Second Example of Lidar Device Coverage

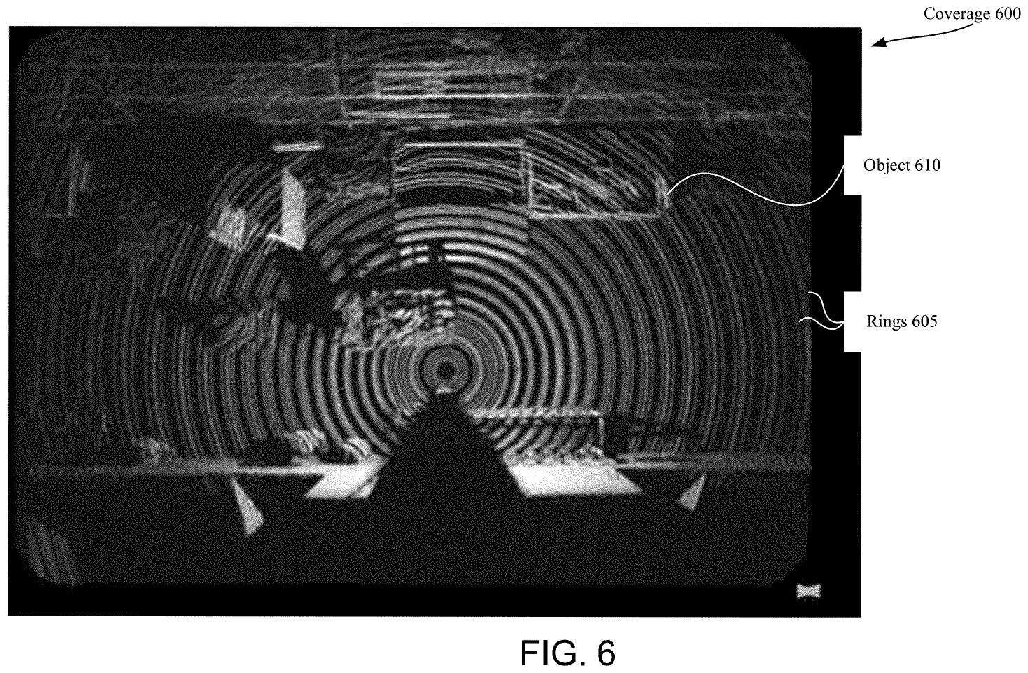

FIG. 6 shows a coverage 600 of an angled lidar unit (e.g., lidar unit 510) of a lidar device that is configured to rotate depicted with rings 605, according to certain embodiments. FIG. 6 may be an example of a view area of the lidar device 505 in FIG. 5B. The example view area shows the view area ring measurement pattern resulting from operation of the lidar device 505. The view area may be from the top-down perspective generated by a lidar device 505 mounted on a ceiling of a room or on a wall of a room.

The illustrated coverage 600 may be generated by a lidar unit, like the lidar unit, described above. The coverage 600 of the lidar unit may be represented as rings 605, depending on the configuration of the lidar unit used to generate the lidar measurements. There may be one or more rings (e.g., 127 rings) 605. In certain embodiments, the distance between rings 605 is uniform. In certain embodiments, the space between rings 605 may vary depending on the physical location of the lidar unit (and by relation, the lidar device) (e.g., X-Y-Z coordinate position, pitch, role, yaw), the angle light was emitted at from the lidar unit, the objects (e.g., object 610) within the line of sight of the lidar unit, and/or the material of the objects (e.g., object 610) within the line of sight of the lidar unit, etc. In certain embodiments, the coverage 600 of the lidar unit and/or lidar device may be represented as a point cloud, in addition or as an alternative to, the ring representation. In certain embodiments, the rings 605 form a point cloud. In certain embodiments, the point cloud is based on one or more sets of one or more rings 605 generated by the lidar device.

The point cloud may be represented on a user device (e.g., by a graphical user interface of the user device). In certain embodiments, the point cloud is represented on the graphical user interface based on the distances measured by the lidar device, objects detected by the lidar device, and/or the lidar device from which the point cloud data was generated by.

The coverage 600, point cloud, and/or other data generated (or generated) by the lidar device and/or lidar unit may be transmitted to and may be used by the graphical user interface to configure the lidar unit, lidar device, system that includes the lidar device, and/or system that uses data generated by the lidar device.

### V. Configuring a Sensor Device Using a User Interface

A user interface can be provided to present to a user the measurements obtained by one or more sensor devices (e.g., lidar devices). The measurements (e.g., like the ones obtained in FIG. 6) may be presented in the form of point clouds. One or more points clouds or other measurements may be presented on the user interface and be used to configure the sensor devices that obtained the one or more measurements. A user interface can be provided for the user to move around a graphical representation of the sensor devices (e.g., lidar device) and/or their corresponding generated data (e.g., point clouds) until alignment is achieved.

### A. Unaligned Sensor Data

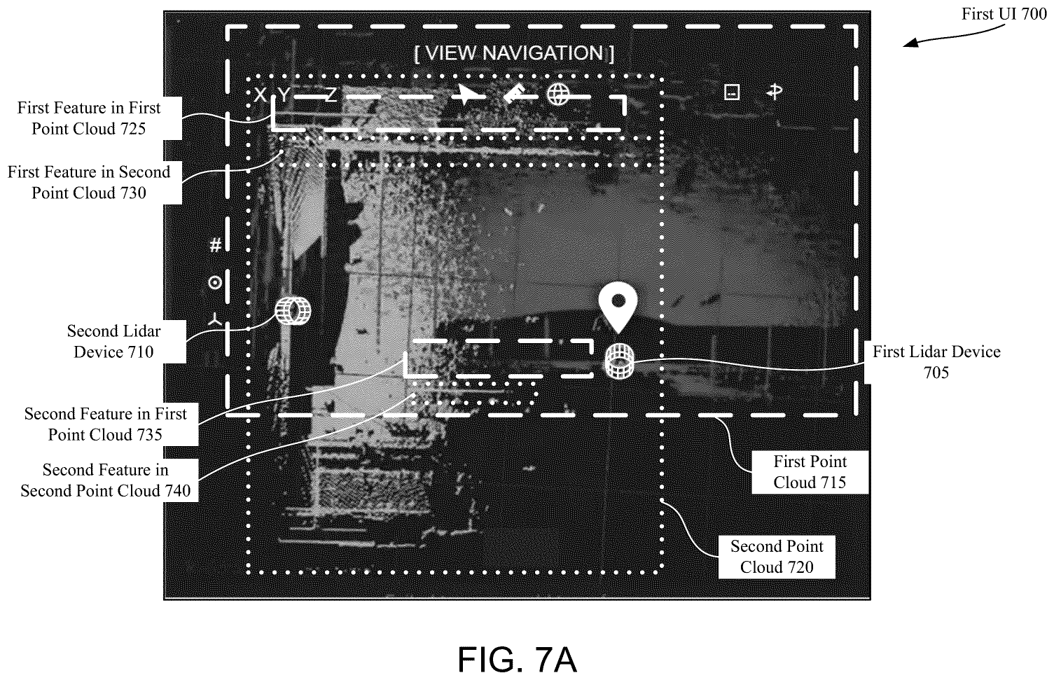

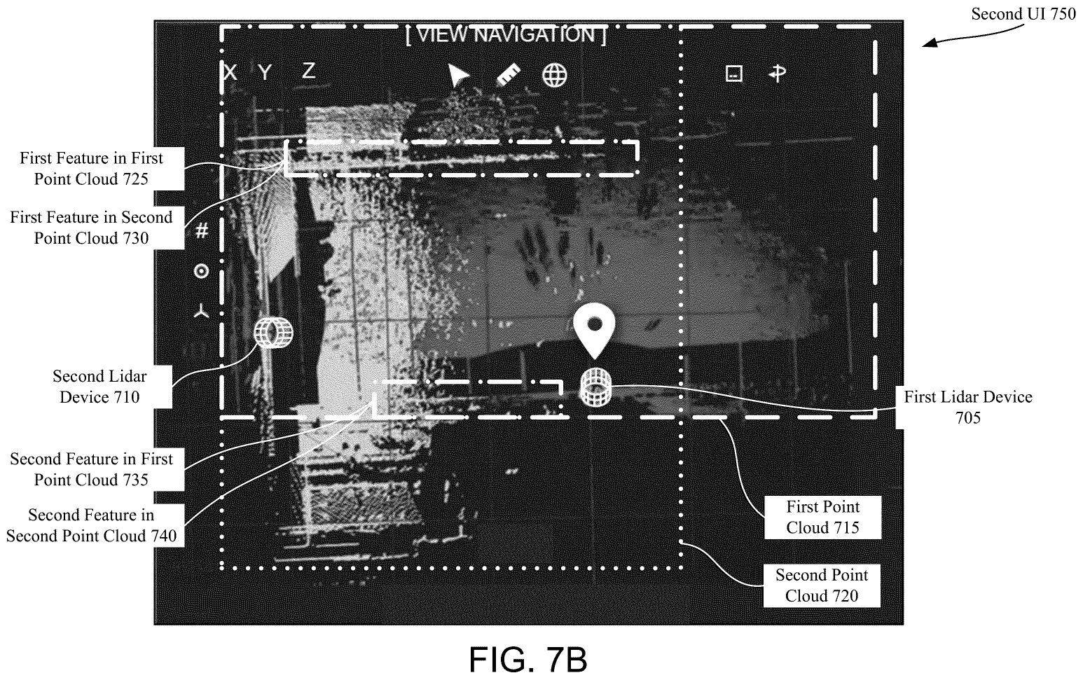

FIG. 7A shows a first UI 700 presentation of two lidar devices with their corresponding point clouds. Each sensor and its corresponding data may be presented using the first user interface (UI) 700 (e.g., displayed on a screen). The two lidar devices include a first lidar device 705 and a second lidar device 710. The first lidar device 705 may generate a first point cloud 715 using techniques described above. The second lidar device 710 may generate a second point cloud 720 using techniques described above. The first lidar device 705 may be in a different physical location than the second lidar device 710. As such, the first point cloud 715 generated by the first lidar device 705 may be different (e.g., include different features (e.g., objects, surface(s) of an object in common)) than the second point cloud 720 generated by the second lidar device 710. In certain embodiments, the second point cloud 720 includes one or more of the same features as the first point cloud 715 but has been generated from the perspective of the second lidar device 710 that is at a different physical location than the first lidar device 705.

First UI 700 illustrates a first point cloud 715 generated by a first lidar device 705 and a second point cloud 720 generated by a second lidar device 710. The first point cloud 715 may correspond with the first lidar device 705 and the second point cloud 720 may correspond with the second lidar device 710. The first UI 700 may present the first point cloud 715 in a manner that is different from the second point cloud 720 to allow a user of the first UI 700 to more easily distinguish the two point clouds. For example, the first point cloud 715 may be presented with a first color or first pattern and the second point cloud 720 may be presented with a second color or second pattern that is different than the first color or first pattern. Other indications may be presented by the first UI 700 to distinguish the first point cloud 715 from the second point cloud 720. In the illustrated first UI 700, the first point cloud 715 appears in a darker color than the second point cloud 720. For the sake of illustration, the first point cloud 715, the first feature of the first point cloud 725 and the second feature of the first point cloud 735 have been surrounded with a dashed line border. For the sake of illustration, the second point cloud 720, the first feature of the second point cloud 730 and the second feature of the second point cloud 740 have been surrounded with a dotted line border. Such a border may or may not be presented by the first UI 700.

The first point cloud 715, second point cloud 720, and any number of other point clouds may include at least some features in common. For example, the first point cloud 715 includes the first feature in the first point cloud 725 and the same first feature is included in the second point cloud 730. As illustrated, the first feature of the first point cloud 725 and the first feature of the second point cloud 730 may not align with one another. When a feature in common of two or more point clouds does not align in the first UI 700, it may represent that the physical spatial relationship between (i) the first lidar device 705 at a first physical location that generated the first point cloud 715, and (ii) the second lidar device 710 at a second physical location that generated the second point cloud 720 is not accurately represented by the virtual locations of the virtual first lidar device 705 and the virtual second lidar device 710 the first UI 700. When the spatial relationship between two or more lidar devices and/or respective point clouds of the lidar devices is not accurately represented by the first UI 700, it may be that the virtual location attributes of one or more of the lidar devices represented by the first UI 700 is incorrectly configured and/or not fully configured. For example, the virtual yaw, X position, Y position, and/or Z position of the first lidar device 705 may not be representative of the physical yaw, X position, Y position, and/or Z position of the physical first lidar device 705.

To cause the virtual location (e.g., virtual yaw, X position, Y position, and/or Z position, or another degree of freedom) of the first lidar device 705 to be representative of the physical location of the first lidar device 705, the first UI 700 may allow a user of the first UI 700 to adjust the virtual location of the first lidar device 705. To cause the virtual location (e.g., virtual yaw, X position, Y position, and/or Z position, or another degree of freedom) of the second lidar device 710 to be representative of the physical location of the second lidar device 710, the first UI 700 may allow a user of the first UI 700 to adjust the virtual location of the second lidar device 710. The user may adjust the virtual location of any number of lidar devices using the first UI 700. By allowing a user to adjust one or more virtual locations of one or more lidar devices, the spatial relationship between two or more lidar devices may be reflected virtually in a manner that is representative of the physical spatial relationship.

The virtual location of a lidar device may be adjusted by receiving input via one or more control elements. The one or more control elements may be used to adjust the virtual location of a point cloud and/or a lidar device. The one or more control elements may provide a field where a user may input a value (e.g., X position, X-Y position, X-Y-Z position, yaw, etc. for a lidar device (e.g., the first lidar device 705). The one or more control elements may provide an area that allows a user to drag and drop the virtual lidar device within the first UI 700. The one or more control elements may provide an incremental step button that allows a user to finely control incrementing and/or decreasing values associated with the virtual location of a lidar device.

The one or more control elements may be used to adjust the perspective of the first UI 700, change colors of the point clouds, label lidar devices, label point clouds, hide point clouds, shown point clouds, send point clouds backward behind other point clouds, bring point clouds forward in front of other point clouds, etc.

In certain embodiments, as the virtual location of the first lidar device 705 or another lidar device is adjusted (e.g., by a user via the one or more control elements), the first point cloud 715 of the first lidar device 705 (or the corresponding point cloud of the other lidar device) may have an adjusted presentation by the first UI 700 (e.g., adjusted virtual location, moved up, moved down, etc.). For example, first UI 700 shows that the first feature in the first point cloud 725 does not align with the first feature in the second point cloud 730. Similarly, the second feature in the first point cloud 735 does not align with the second feature in the second point cloud 740.

First UI 700 shows that the features in the second point cloud 720 are presented below the first point cloud 715 features and offset to the right of the corresponding first point cloud 715 features. The presentation by the first UI 700 may allow a user of the first UI 700 to determine that the displayed spatial relationship between the virtual location of the first lidar device 705 and the second lidar device 710 are not reflective of the physical spatial relationship between the first lidar device 705 and the second lidar device 710 because the point clouds generated by each of the lidar devices do not reflect the same features in an aligned position.

The first UI 700 may allow for the second point cloud 720 to be adjusted and/or the first point cloud 715 to be adjusted so that the point clouds (e.g., and features in in common included in the point clouds) more closely align with one another (e.g., adjusted so that the first feature in the first point cloud 725 aligns with the first feature in the second point cloud 730). Adjustment of the point clouds may be performed using one or more control elements.

The second UI 750 in FIG. 7B illustrates what may be presented by the second UI 750 after user input via the one or more control elements causes the first point cloud 715 to align with the second point cloud 720.

### B. Aligned Sensor Data

FIG. 7B shows a second UI 750 presentation including two lidar devices where the first point cloud 715 and the second point cloud 720 align, according to certain embodiments. The second UI 750 presentation includes two lidar device where the second lidar device 710 has been moved up and to the left with respect to the first UI 700 so that the first point cloud 715 and the second point cloud 720 align.

In addition to moving a lidar device around in the 3D model, the yaw of the lidar device can be moved. In certain embodiments, other sensors may be represented in the UI. For example, a first point cloud 715 generated by a first lidar device 705 may be included in the UI and an image generated by a camera may be included in the UI. The virtual location of the camera and the image generated by the camera may be presented in the UI in a manner similar to a lidar device and point cloud. The image generated by the camera may be presented by the UI and used to help adjust the relative spatial relationship between the camera, the first lidar device 705, and/or any other device represented in the UI. Data from other sensors may be presented by the UI and used to configure the other sensors and/or lidar devices. For example, an infrared sensor and its data may be used to configure the location of one or more infrared sensors and/or other sensor devices.

The second UI 750 illustrates that the first feature in the first point cloud 725 and the first feature in the second point cloud 730 align. The second UI 750 further illustrates that the second feature in the first point cloud 735 and the second feature in the second point cloud 740 align. Since at least one feature of the first point cloud 715 and the second point cloud 720 align, the virtual location of the first lidar device 705 and the virtual location of the second lidar device 710 may more accurately represented the physical locations of the respective first and second physical lidar devices that were used to generate the point clouds.

In certain embodiments, a particular object is physically placed in a line of sight of two or more lidar devices so that the configuration of the lidar devices in the UI can be performed by aligning the particular physical object feature of the two or more points clouds generated by the respective two or more lidar devices.

In certain embodiments, once the two point clouds of two sensors mostly overlap, an automatic align option can provide refinement. Once the two points clouds are sufficiently close, one or more common points (e.g., corners) in each point cloud can be identified (e.g., by a user, using an image recognition algorithm), and one of the devices can be automatically translated and rotated (e.g., by the computer as opposed to the user) as needed. To help this process, a particular object may be placed in the environment and that object can be keyed on to help the alignment process. The automatic align may be performed using an iterative closest point (ICP) algorithm to minimize the distance between corresponding point cloud points.

Additionally, a single sensor can be aligned to place a particular object at a particular coordinate. For example, it may be desirable for a desk or lamp to be placed at the origin of the reference frame.

In certain embodiments, one or more features in common between the two or more lidar devices may be used to cause an automatic alignment. The automatic alignment may use image recognition, color matching, object boundaries, pixel locations, point cloud point positioning, and/or user input to cause corresponding features of two or more point clouds to be aligned. In certain embodiments, once a user uses the one or more control elements to substantially align two or more point clouds, another control element may be used to cause the point clouds to be automatically aligned. The automatic alignment of one or more point cloud features of one or more point clouds may cause the corresponding lidar devices that generated the point clouds to have virtual spatial locations that are representative of the spatial relationship between the two or more physical lidar devices that generated the two or more point clouds.

In certain embodiments, one or more control elements may allow for a single or multiple virtual location characteristics of one or more lidar devices (or other devices) to be configured. For example, the X coordinate position of the lidar device may be changed using an control element. In an example, the X-Y position may be changed simultaneously using a control element. In certain embodiments, the activation of the image control elements may be toggled ON/OFF (e.g., by the user of the UI) as a form of selecting which type of control will be performed (e.g., drag and drop the device in a virtual location versus adjusting yaw).

In certain embodiments, a global origin for the devices presented in the UI may be set. The global origin may be set based on a virtual location of one or more of the devices shown (e.g., at the origin of one of the devices, between the devices). The global origin may be set based on user input that defined where the global origin should be. The global origin may be set based on a specific object identified or the location of a specific object that has been identified in a point cloud displayed on the UI.

### C. Yaw Angle Adjustment Control Element

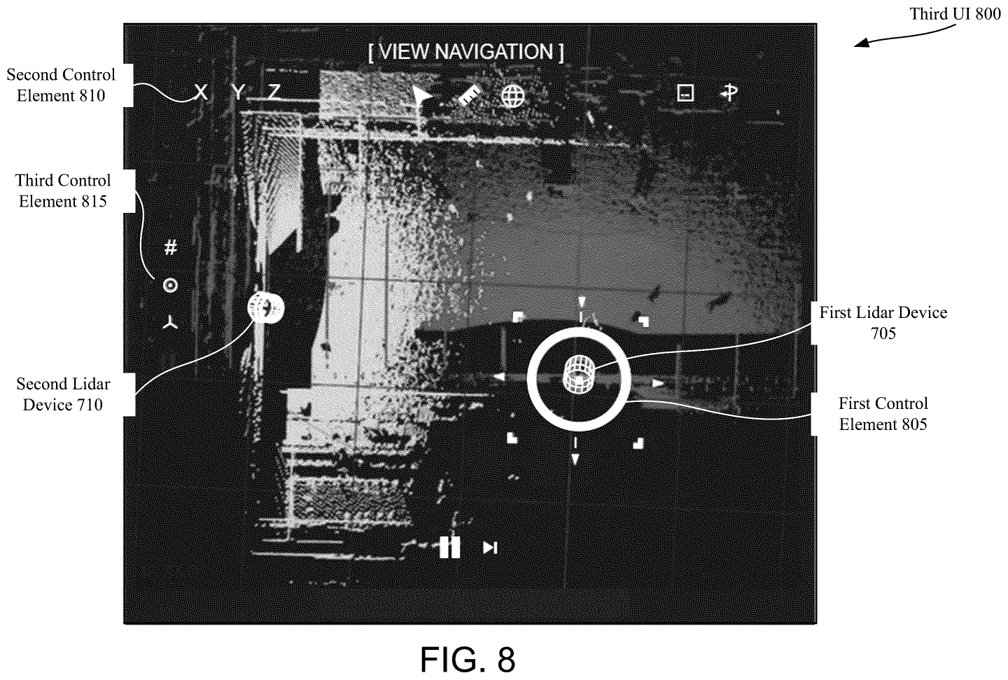

FIG. 8 shows a third UI 800 with a circular first control element 805 around the first lidar device 705 that may be used for adjusting the yaw angle, according to certain embodiments. In certain embodiments, after tapping on the first control element 805, the first lidar device 705 can be rotated. In certain embodiments, the first lidar device 705 can then be translated (e.g., moved virtually up or down) again by selecting the blue corners in a box around the first lidar device 705.

The third UI 800 may include any number of control elements. For example, the third UI 800 may include control elements (e.g., a second control element 810, a third control element 815) that may function in a manner similar to the control elements described above.

### D. Automatic Alignment

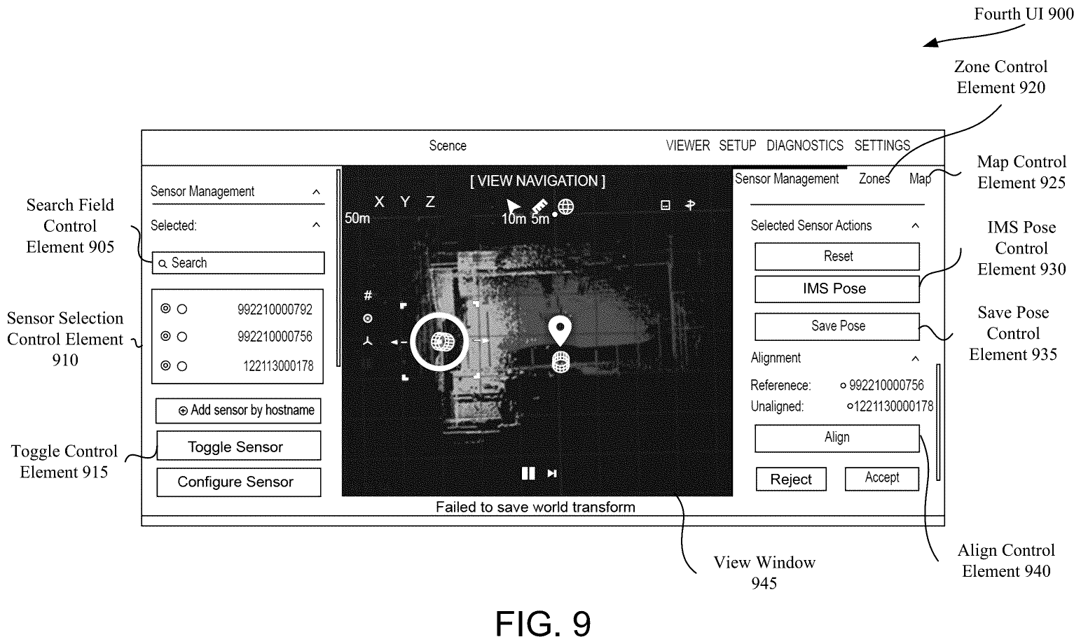

FIG. 9 shows a fourth UI 900 with an automatic align feature, according to certain embodiments.

The fourth UI 900 may include any number of control elements (e.g., such as the control element discussed above). The fourth UI 900 is illustrated as including a search field control element 905, a sensor selection control element, a toggle control element 915, a zone control element 920, a map control element 925, a IMS pose control element 930, a save pose control element 935, and an align control element 940, among others. The illustration of control elements in the fourth UI 900 is not meant to be limiting and is meant to be exemplary.

The search field control element 905 may allow for a specific device identifier (e.g., type of device, device physical location, device virtual location, device name, device number, etc.) to be searched for. The search may allow a user to select a device to display in the center view window 945, find a device already in the view window 945, etc.

The sensor selection control element may allow for sensors to be selected for inclusion in the view window 945. Sensors may be added to the view window 945 so that their virtual location can be configured to be representative of their physical location. The sensors selection control element may be used after searching for a sensor in the search field control element 905.

The toggle control element 915 may enable the capability for a sensor and/or its corresponding data to be presented or not presented in the view window 945 by hiding or showing the point cloud data and/or the virtual sensor.

The zone control element 920 may allow for navigation between zones of a map. For example, a map may include a set of zones, and the set of zones may include a set of sensors. As an example, a building may include a map, the map of the building may have room zones that are included in the building map, and the room zones may include any number of sensors.

The map control element 925 may allow for the navigation between maps. For example, a set of lidar devices may be being configured (e.g., after being physically installed). A user of the fourth UI 900 may view a specific map using the map control element 925 and/or a specific zone of the map using the zone control element 920. The view window 945 may be capable of displaying a one or more zones and/or one or more maps at a single time. Lidar devices, and other devices, may be displayed in a virtual location within the zones and/or maps.

The IMS pose control element 930 may be capable of being interacted with to cause an IMS (e.g., an IMS of a lidar device) to obtain sensor data relating to roll and/or pitch. The obtained pitch and/or roll of the corresponding virtual device may be set according to the obtained sensor data. Obtaining the pitch and/or roll may reduce the amount of time, processing resources, etc. used to configure the device compared to not being able to obtain and assign the pitch and/or roll of the device using the IMS (e.g., compared to a user manually causing the pitch and/or roll of the virtual device to correspond to the pitch and/or roll of the physical device).

The align control element 940 may be interacted with to cause automatic alignment of two or more point clouds, images, images and point clouds, etc. The align control element 940 may perform functions to the automatic alignment functions as described above.

### VI. Method of Sensor Device Configuration

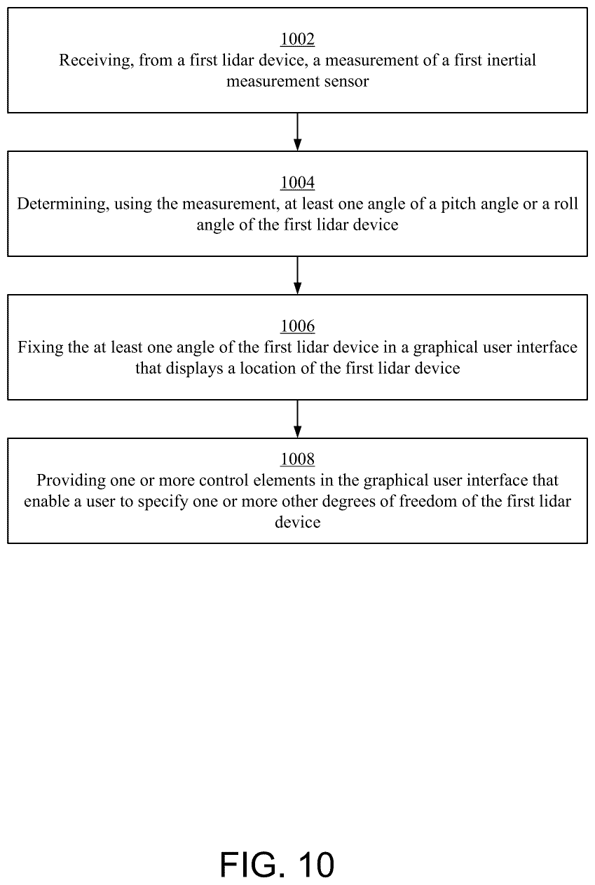

FIG. 10 shows a process for configuring a sensor virtual location, according to certain embodiments. The sensor's virtual location may be represented in a graphical user interface and may correspond to a physical location of a corresponding physical sensor.

At 1002, a measurement may be received from a first lidar device. The first lidar device may include an IMS. The received measurement may be from the IMS. The received measurement may be received from an accelerometer of the IMS and may indicate a direction of gravitational pull.

At 1004, a determination may be made using the measurement. At least one angle of a pitch angle or a roll angle of the first lidar device may be determined using the measurement. The direction of gravitational pull determined using the IMS may be used to determine the pitch and the role of the first lidar device since the direction of gravity with respect to the lidar device may indicate the pitch and the role of the lidar device.

At 1006, at least one angle (e.g., pitch, role) of the first lidar device may be fixed in a graphical user interface and may be represented by a virtual lidar device. The at least one angle may be fixed so that the user of the user interface cannot adjust the at least one angle and the at least one angle is defined by the angle(s) determined using the IMS of the lidar device.

The graphical user interface may display a virtual location of the first lidar device. The virtual location of the first lidar device may correspond to a physical location of the first lidar device in a physical space. The virtual location of the first lidar device may be with respect to six degrees of freedom and a global origin. The six degrees of freedom may include three dimensional coordinate positions (e.g., X, Y, Z), pitch, role, and yaw.

The virtual location of the first lidar device may be presented by the graphical user interface. A point cloud of one or more points may be presented by the graphical user interface. The point cloud may be a point cloud generated using the physical lidar device. The point cloud may be presented in a color, pattern, or other identifying characteristic capable of being presented on the graphical user interface that corresponds to the physical lidar device used to generate the point cloud.

The virtual location of the first lidar device may be with respect to an origin. In certain embodiments, the origin is the same as the location of the virtual lidar device. In certain embodiments, the origin may be defined using the graphical user interface. In certain embodiments, the origin is predefined (e.g., based on a virtual location in a database, based on a physical object detected by the lidar device) and displayed by the graphical user interface.

At 1008, one or more control elements may be provided in the graphical user interface. The one or more control elements may enable a user to specify one or more other degrees of freedom of the virtual first lidar device. The one or more control elements may include buttons that allow for the user to incrementally adjust at least one of the degrees of freedom up or down. The one or more control elements may include a draggable element for adjusting the degrees of freedom of the lidar device represented in the graphical user interface. The one or more control elements may include a field that may be used to enter at least one virtual location attribute (e.g., X position, Y position, Z position, yaw) of the lidar device. The virtual location attributes may be the same as or similar to the physical location attributes of the lidar device.

In certain embodiments, process 1000 is performed for at least a second lidar device or other sensor device. The second lidar device may be configured in a similar manner as described for the first lidar device. For example, a second lidar device may be installed at a second physical location. A second IMS of the second lidar device may be used to determine at least on angle of the second lidar device and cause the at least one angle to be fixed in the graphical user interface. The user of the user interface may then be able to adjust the virtual location of the second lidar device while the at least one angle of the second device remains fixed (e.g., immovable by the user).

The first lidar device and the second lidar device may each have their virtual locations presented by a graphical user interface. The first lidar device, the second lidar device, and any number of other lidar devices may be configured using the same graphical user interface. In certain embodiments, the first point cloud generated by the first lidar device and the second point cloud generated by the second lidar device may be presented by the graphical user interface (e.g., simultaneously). By presenting the first point cloud and the second point cloud using the graphical user interface, the first lidar device and/or second lidar device may be configured.

In certain embodiments, configuring the location of the second lidar device may be informed by the point cloud of the first lidar device. For example, the housing of the second lidar device may be captured in the first point cloud of the first lidar device. In certain embodiments, configuring the location of the second lidar device may be informed by the point cloud of the first lidar device and the second lidar device. For example, one or more features reflected by the first point cloud may also be reflected by the second point cloud and therefore, allowing the user to align the first point cloud and the second point cloud may allow for the locations of the first lidar device and the second lidar device to be accurately configured with respect to one another because the point clouds have been generated with by the respective lidar device at a position relative to the point cloud.

After the sensor (e.g., lidar) virtual location information is saved, the physical location of the physical sensor and/or the spatial relationship between two or more physical sensors may be known. The location (virtual and/or physical) of the sensors may be used to perform calculations, reconstruct three dimensional spaces, monitor surroundings of a car and/or building, survey land, medical imaging, object detection, facial recognition, AR/VR content creation, CAD modeling, path planning, etc. In certain embodiments, the configured virtual location of the sensors does not need to reflect the exact location of the physical sensors, embodiments (e.g., via automatic aligning or being closely aligned) may still allow for improved sensor accuracy to be provided from the described embodiments.

### VII. Example Computer System

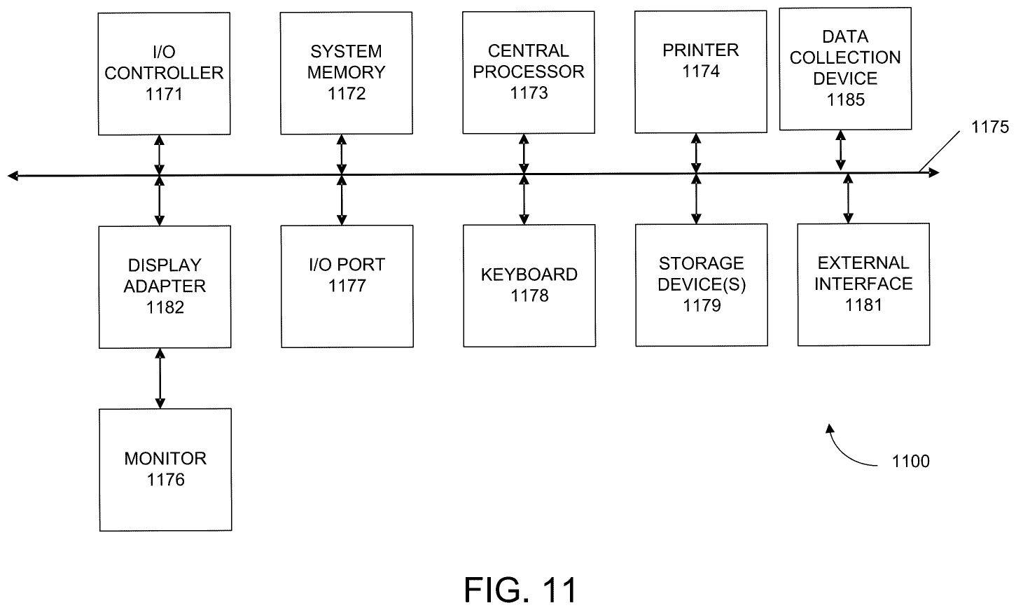

Any of the computer systems (e.g., User Interface Hardware & Software 315) mentioned herein may utilize any suitable number of subsystems. Examples of such subsystems are shown in FIG. 11 in computer system 1100. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 1175. Additional subsystems such as a printer 1174, keyboard 1178, storage device(s) 1179, monitor 1176, which is coupled to display adapter 1182, and others are shown. Peripherals and input/output (I/O) devices, which couple to I/O controller 1171, can be connected to the computer system by any number of means known in the art such as input/output (I/O) port 1177 (e.g., USB, Fire Wire®). For example, I/O port 1177 or external interface 1181 (e.g. Ethernet, Wi-Fi, etc.) can be used to connect computer system 1110 to a wide area network such as the Internet, a mouse input device, or a scanner. The interconnection via system bus 1175 allows the central processor 1173 to communicate with each subsystem and to control the execution of a plurality of instructions from system memory 1172 or the storage device(s) 1179 (e.g., a fixed disk, such as a hard drive, or optical disk), as well as the exchange of information between subsystems. The system memory 1172 and/or the storage device(s) 1179 may embody a computer readable medium. Another subsystem is a data collection device 1185, such as a camera, microphone, accelerometer, and the like. Any of the data mentioned herein can be output from one component to another component and can be output to the user.

A computer system can include a plurality of the same components or subsystems, e.g., connected together by external interface 1181, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A method comprising performing by a computer system in communication with a lidar device that includes an inertial measurement sensor:
receiving, from the lidar device, a measurement of the inertial measurement sensor;
determining, using the measurement, at least one angle of a pitch angle or a roll angle of the lidar device;
fixing the at least one angle of the lidar device in a graphical user interface that displays a location of the lidar device; and
providing one or more control elements in the graphical user interface that enable a user to specify one or more other degrees of freedom of the lidar device.

2. The method of claim 1, wherein the at least one angle is both the pitch angle and the roll angle.

3. The method of claim 1, wherein the computer system is in communication with a second lidar device that includes a second inertial measurement sensor, the method further comprising:
receiving, from the second lidar device, a second measurement of the second inertial measurement sensor;
determining, using the second measurement, at least one second angle of a second pitch angle or a second roll angle of the second lidar device;
fixing the at least one second angle of the second lidar device in the graphical user interface that displays a second location of the second lidar device; and
providing the one or more control elements in the graphical user interface that enable the user to specify one or more other degrees of freedom of the second lidar device.

4. The method of claim 3, further comprising:
providing a first point cloud of the lidar device and a second point cloud of the second lidar device based on current positions specified in the graphical user interface; and
receiving user input via the one or more control elements to align the first point cloud and the second point cloud.

5. The method of claim 4, further comprising:
presenting the first point cloud using at least one of: (i) a first color or (ii) first pattern; and
presenting the second point cloud using at least one of: (i) a second color different than the first color or (ii) a second pattern different than the first pattern.

6. The method of claim 3, further comprising:
providing a first point cloud of the lidar device and a second point cloud of the second lidar device based on current positions specified in the graphical user interface; and
receiving input causing the first point cloud and the second point cloud to be aligned.

7. The method of claim 6 wherein aligning the first points cloud and the second point cloud, further comprises:
adjusting at least one degree of freedom of the lidar device or the second lidar device to align with an object in the first point cloud, the object also reflected by the second point cloud.

8. The method of claim 6, wherein receiving the input causing the first point cloud and the second point cloud to be aligned occurs when the first point cloud and the second point cloud are substantially aligned.

9. The method of claim 1, further comprising:
receiving user input via the one or more control elements to change at least one of: (i) a position of the lidar device in the graphical user interface or (ii) a yaw included in the one or more other degrees of freedom of the lidar device in the graphical user interface.

10. The method of claim 9, wherein receiving the user input via the one or more control elements further comprises at least one of: (i) receiving a coordinate position via the one or more control elements or (ii) receiving an incremental adjustment to at least one degree of freedom.

11. The method of claim 1, wherein receiving the measurement of the inertial measurement sensor further comprises:
receiving the measurement indicating a direction of gravitational pull from an accelerometer of the inertial measurement sensor.

12. A non-transitory computer-readable medium storing instructions for controlling a processor, communicably coupled with a computing system, and configured to perform the following operations:
receiving, from a lidar device, a measurement of a inertial measurement sensor;
determining, using the measurement, at least one angle of a pitch angle or a roll angle of the lidar device;
fixing the at least one angle of the lidar device in a graphical user interface that displays a location of the lidar device; and
providing one or more control elements in the graphical user interface that enable a user to specify one or more other degrees of freedom of the lidar device.

13. The non-transitory computer-readable medium of claim 12, wherein the computer system is in communication with a second lidar device that includes a second inertial measurement sensor, the operations further comprising:
receiving, from the second lidar device, a second measurement of the second inertial measurement sensor;
determining, using the second measurement, at least one second angle of a second pitch angle or a second roll angle of the second lidar device;
fixing the at least one second angle of the second lidar device in the graphical user interface that displays a second location of the second lidar device; and
providing the one or more control elements in the graphical user interface that enable the user to specify one or more other degrees of freedom of the second lidar device.

14. The non-transitory computer-readable medium of claim 13, further comprising:
providing a first point cloud of the lidar device and a second point cloud of the second lidar device based on current positions specified in the graphical user interface; and
receiving user input via the one or more control elements to align the first point cloud and the second point cloud.

15. The non-transitory computer-readable medium of claim 13, further comprising:
providing a first point cloud of the lidar device and a second point cloud of the second lidar device based on current positions specified in the graphical user interface; and
receiving input causing the first point cloud and the second point cloud to be aligned.

16. The non-transitory computer-readable medium of claim 15, wherein aligning the first points cloud and the second point cloud, further comprises:
adjusting at least one degree of freedom of the lidar device or the second lidar device to align with an object in the first point cloud, the object also reflected by the second point cloud.

17. The non-transitory computer-readable medium of claim 15, wherein receiving the input causing the first point cloud and the second point cloud to be aligned occurs when the first point cloud and the second point cloud are substantially aligned.

18. A lidar device comprising:
a lidar unit that includes emitters configured to emit light and sensors configured to detect reflected light;
an inertial measurement sensor that measures at least one angle of a pitch angle or a roll angle of the lidar device; and
a network interface configured to receive a request for the measurement and to provide the measurement to a computer system, the computer system configured to:
receive, from the lidar device, a measurement of the inertial 8 measurement sensor;
determine, using the measurement, at least one angle of the pitch angle or the roll angle of the lidar device;
fix the at least one angle of the lidar device in a graphical user interface that displays a location of the lidar device; and
provide one or more control elements in the graphical user interface that enable a user to specify one or more other degrees of freedom of the lidar device.

19. The lidar device of claim 18, wherein the computer system is in communication with a second lidar device that includes a second inertial measurement sensor and is further configured to:
receive, from the second lidar device, a second measurement of the second inertial measurement sensor;
determine, using the second measurement, at least one second angle of a second pitch angle or a second roll angle of the second lidar device;
fix the at least one second angle of the second lidar device in the graphical user interface that displays a second location of the second lidar device; and
provide the one or more control elements in the graphical user interface that enable the user to specify one or more other degrees of freedom of the second lidar device.

20. The lidar device of claim 19, wherein the computer system is further configured to:
provide a first point cloud of the lidar device and a second point cloud of the second lidar device based on current positions specified in the graphical user interface; and
receive user input via the one or more control elements to align the first point cloud and the second point cloud.
